(19) United States
(12) Patent Application Publication
(10) Pub. No.: US 2008/0162435 A1
(43) Pub. Date: Jul. 3, 2008

(54) Retrieving Content Items For A Playlist Based On Universal Content Id

(75) Inventors: Jacobus Dooms, Eindhoven (NL); Jeroen Franciscus Hubertus Van Agt, Eindhoven (NL); Bernardus Petrus Hendricus Catharina Van Gompel, Eersel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,855

(22) PCT Filed: Feb. 20, 2006
(86) PCT No.: PCT/IB06/50548

§ 371 Date: Aug. 22, 2007

Related U.S. Application Data
(60) Provisional application No. 60/655,081, filed on Feb. 22, 2005.

(51) Int. Cl. G06F 17/30

(52) U.S. Cl. 707/3; 707/E17.014

(57) ABSTRACT

Playlist retrieval based on a universal identification is provided. A selected entry on a playlist is identified (S2). A universal unique media identification for the entry is extracted (S3) and based on the universal identification, a medium storing the selected content item is located (S5) and content data corresponding to the selected entry of the playlist is retrieved (S7) via a network, for example, from a remote server, and stored (S8) or output (S9). The universal identification can be generated using a hash algorithm from the content data, and a hash table can be used to identify the content data based on the universal identification by the remote server.

The present invention relates to retrieval of a content item, such as a song, a audio data, or video information, selected for a playlist, and to universal unique content identification.

The emergence in recent years of digital representations of music, content items representing songs or music no longer need to be grouped in an album published by a record label. Users have increasingly turned to playlists as a means of organizing, sharing, storing, and playing music. Such playlists represent the musical tastes and preferences of the user, allow users to compile a “mix” of songs for a particular occasion, for sharing with another user, for achieving a particular mood, and allow organization centered around a general theme, artist or genre as determined by the user's preferences.

However with the emergence of the Internet, users are no longer bound to musical selections locally stored on their media player or personal database. Users can compile a playlist without the need to store locally the music entries on the playlist. Further, the storage capacity of storage devices and databases, including hard drives on personal computers and on other types of storage media has been rapidly increasing in recent years, thus allowing users to compile larger and longer playlists.

Systems have been devised to retrieve music stored remotely for playback on a media player. Qureshey et al., U.S. Patent Application Publication No. 2002/0002039 discloses a network-enabled audio device in which users can compose playlists from disk files, CDs, Internet streaming audio broadcasts, online music sites and other audio sources, such that a list of devices in the user's Internet personal audio network is generated with the relevant songs thereon. O'Rourke et al., U.S. Patent Application Publication No. 2003/0028505, discloses streaming media for services which associate content with a particular playlist, such that based on an entry, a streaming media content server uses a URL or another reference that indicates the media content and the source, based on which the media content is streamed back to the requesting computer. Springer Jr. et al., U.S. Patent Application Publication No. 2004/0034650, discloses a media identifier registry which stores a unique logical identifier for each record as well as a type corresponding to each of the logical identifiers, thus allowing the building of a media data warehouse uniquely identifying the same piece of content from different data providers.

Further, various schemes for song retrieval exist. Platt, U.S. Patent Publication No. 2003/0221541 discloses an automatic playlist generator, in which several seed songs, including “undesirable seed” songs are used to generate songs on a playlist. Cluts, U.S. Pat. No. 5,616,876 discloses selecting additional songs that are like a first set of songs, based on “style labels” for each song previously written by an editor. However, none of these references discloses retrieving a content item corresponding to an entry on a playlist, based on universal identification.

It is also possible of course for a user to retrieve a desired content item such as a song, however attempting to locate the content item can be a time-consuming and onerous job, particularly if the location of the item is not known by the user.

Provided are a method, system, device, apparatus, and computer-readable media that embodies or carries out the functions of playlist retrieval. First, a selected entry on a playlist is identified. A universal identification for the entry is extracted, the universal identification uniquely identifying content data medium. Based on the universal identification, a medium, such a remote server, storing the selected content data is located. The content data from the storing medium is retrieved and may be output.

The outputting may be by storing the content item associated with the entry on a local storage and/or by streaming the data to a playback device, such as. for example, a speaker and/or an image display.

Further, the content item may be retrieved from a database via a network.

The medium storage server can identify the content data based on the universal identification by a hashing algorithm or with reference to a hashing table.

The universal identification may be obtained by applying a hashing function to the content data.

The content data may comprise audio data or other types of content, such as pictures, video data, documents, text files, and the like.

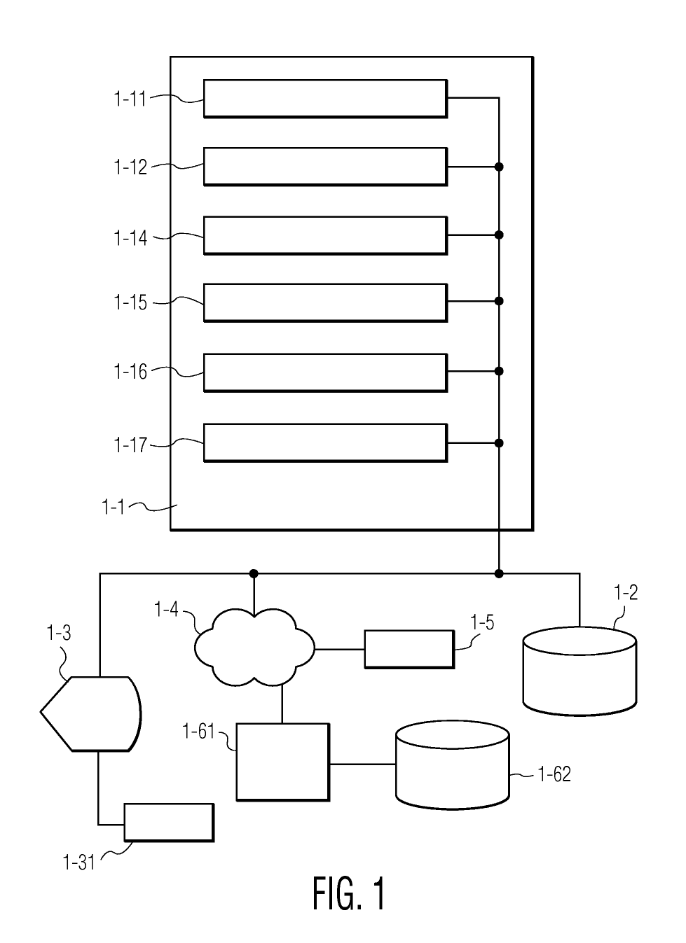

FIG. 1 is a schematic view of a retriever according to an embodiment of the present invention.

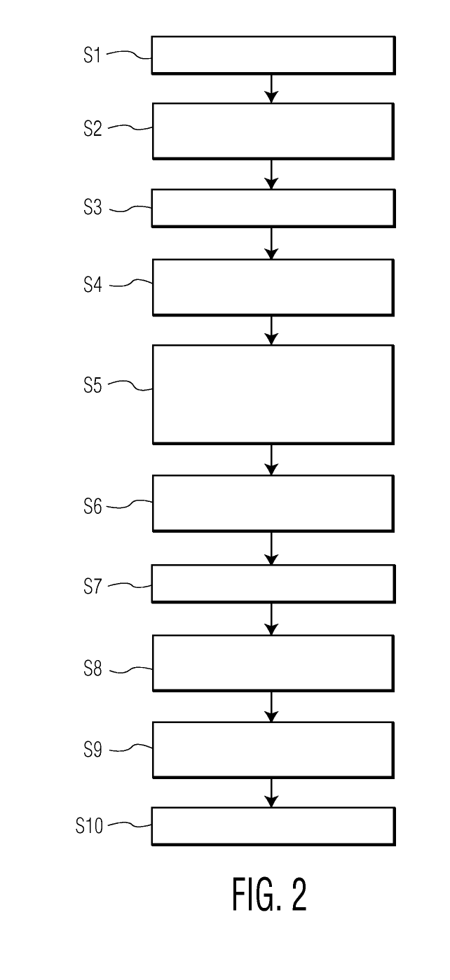

FIG. 2 is a flowchart showing an operation of a system according to the present invention.

The following discussion and the foregoing figures describe embodiments of Applicant's invention as best understood presently by the inventors however, it will be appreciated that numerous modifications of the invention are possible and that the invention may be embodied in other forms and practiced in other ways without departing from the spirit of the invention. Further, features of embodiments described may be omitted, combined selectively or as a whole with other embodiments, or used to replace features of other embodiments, or parts thereof, without departing from the spirit of the invention. The figures and the detailed description are therefore to be considered as an illustrative explanation of aspects of the invention, but should not be construed to limit the scope of the invention.

As shown in FIG. 1, the retriever 1-1 includes several modules, which will be described below. Modules of the retrieval system 1-1, or portions thereof, and/or the retrieval system as a whole, may be comprised of hardware, software, firmware, or a combination of the foregoing, however some modules may be comprised of hardware for example, while other modules may be comprised of software, firmware or a combination thereof. Further, it will be appreciated that modules of the retrieval system need not all be located or integrated with the same device. A distributed architecture is also contemplated for the retrieval system, such that the system or components thereof may “piggy-back” off of suitable modules provided by existing devices.

The following description will refer to a retriever 1-1 that is physically integrated with or connected to a database 1-2 via a wired or wireless connection thereto. The retriever and/or the database 1-2 may be embodied as physically integrated with or connected to a device such as an MP3 player, a CD or minidisk player, a data cartridge player, a home entertainment system, a handheld entertainment device, a hard drive of a personal computer, a personal video recorder, an entertainment system, an electronic organizer, a personal handheld device, a Jaz drive, or may be embodied as a commercial storage facility, such as a disk drive. It will be understood that the database 1-2 may include several storage devices that are connected, such that organization or grouping of content items on two or more of such devices is possible. It will further be understood that the database may be understood to include one or more storage media, such as disks, including CDs, DVDs, zip disks, floppy disks, data cartridges, or the like, which can be loaded onto and retrieved by the database 1-2. However, it will be understood that the retriever 1-1 is also capable of storing content in a remote storage (not shown) via a network 1-4, such as a LAN, WAN, the Internet, or the like. While aspects of the present invention will sometimes be illustrated with reference to audio content items or songs referenced by entries of the playlist, the present invention is not limited to music playlists but may also include playlists including as entries other types of content items, such as video, photograph, text file, spreadsheet, html, xml, multimedia or other types of files, documents, content, or data, or some combination of the foregoing.

FIG. 1 shows a retriever 1-1 that comprises several modules, including a playlist processor 1-11, which interfaces with media player 1-3. Retriever 1-1 may be physically integrated with or connected to the media player 1-3 or connected thereto via a wired or wireless connection. Retriever 1-1 interfaces with a media player 1-3 by receiving information about a playlist from the media player 1-3 processed by playlist processor 1-11, and identifies a selected entry on the playlist. Retriever 1-1 further comprises a universal identification extractor 1-12, which extracts a universal identification associated with the selected entry of the playlist; a media target associator 1-14, which, based on the extracted universal identification or in some other way, identifies a storage medium, such as medium storage server 1-61, on which the content data referenced by the selected entry of the playlist is stored; and a server interface 1-15, which sends a request to the identified medium storage server 1-61 for the content data.

The medium storage server 1-61 may store the content data or may identify the content data, such as a song requested, whereupon a content database 1-62 containing the requested audio content file is accessed by the medium storage server 1-61, and the requested content data is returned via network 1-4 to the server interface 1-15. The universal retriever 1-1 further comprises an output 1-16 which provides, for example by streaming data, the retrieved content data to a media player 1-3 for sounding a speaker 1-31 connected to the media player 1-3, and/or for storing the retrieved content data in the database 1-2 associated with the playlist entry. It will be understood that although shown as a speaker 1-31, this output node may additionally comprise an image display for playback of video or other visual information or content, in addition to or instead of the speaker. Controller 1-17 may coordinate overall functioning of the retriever 1-1, and may interact with one or more devices external to the retriever 1-1, such as with a user interface (not shown), by accepting commands and transmitting status information to a display (not shown).

A playlist compiled by retriever may include content items such as one or more songs, music or audio data, video data, data comprising a motion picture or portion thereof, photo data, text files, or other types of multimedia data, a JPEG file, MPEG (including MPEG-2, MPEG-3, or the like), or XML data. Music data may comprise one or more MP3 files or the like, and so forth.

An operation of the retriever 1-1 according to an embodiment of the present invention will now be described with reference to FIGS. 1 and 2. At S1 of FIG. 2, processing for retrieving a content item associated with an entry on a playlist is commenced. For example, a user (not shown) may have compiled a playlist made up of entries, each entry, for example, including a song title with associated metadata or other entry description data, and may now wish to retrieve content data for a song for which the entry includes the title and some metadata. At S2 of FIG. 2, a selected entry on a playlist is identified by playlist processor 1-11.

The entry may include the universal identification, which could be entered by the user, or, may be included with metadata or other associated information.

According to an embodiment of the present invention, the universally unique ID can be determined from the digital content, and accordingly this makes it likely that the same universal ID yields the same song, and vice versa the same song yields the same universal ID. In this way, the universal ID uniquely identifies the song world wide. For example, if a list contains one or more pieces of metadata, the content data for the item, such as the song data, and the universal ID as follows:

1 <artist>=“Jimi Hendrix” <title>=“All along the watchtower”
0x123456789A, ID1
2 <artist>=“Jimi Hendrix Experience” <title>=“All along the watchtower,
remastered” 0x123456789A ID1
3 <artist>=“Jimi Hendrix” <title>=“All along the watchtower”
0xA987654321 ID2

then of the three songs, two (song 1 and song 3) have the same metadata, and two other songs (1 and 2) have the same song data. In this case the content data for songs 1 and 2 should yield the same unique ID.

According to an embodiment of the invention, the universal IDs are generated based on the content data at a site other than the retriever 1-1. Moreover this generation is such that different songs tend to get different universal IDs, and the same universal ID yields same song. However, according to an aspect of the present invention, hashing is used for this purpose, although this does not necessarily provide a 100% guarantee that there can be no universal ID collision (more than one content item yielding the hash value). The desired characteristics of a hash function in general are that H(x)≠H(y) implies x≠y and that H(x)=H(y) probably implies that x=y. With a good hashing algorithm however, such as for purposes of illustration, SHA-1 for instance or MD5, chances of a collision are very low.

According to an aspect of the present invention, in obtaining the hash value all of the content data, or all of the content data as sampled at given intervals for a specified time, may be used.

According to an aspect of the present invention, a playlist includes entries that include the universal ID and possibly other metadata but not the actual content data (for example the data that comprise the song data). Then, the universal ID uniquely identifying the content item is extracted for the selected entry and the content data is retrieved.

Further, the universal ID may be automatically located or extracted by the retriever 1-1 from the media player 1-3, the local database 1-2, or from the server for 1-5 via the network 1-4 based on metadata contained in the entry. For example, server 1-5 may provide the universal identification based on metadata or other information associated with the selected entry on the playlist.

According to an embodiment of the present invention, each entry may include description information, such as metadata and usage history data. Such description data may include any one or more of the following:

the title, the content type, including the type of data, such as music, audio, video, photo, text file, et cetera; the content style or genre, such as jazz music, 1950's Era, holiday movie, personal landscape photography, or the like; time and/or location of the creation of the item, time and/or place of acquisition of the item; usage history of the item, such as the last/first/penultimate etc. time and/or location and/or context of playback and/or editing, a place of creation of the item, a place of acquisition of the item, a place of last usage; and an artist or performer or the like associated with the entry.

It will be understood that further description data about the entry may be located from other sources and extracted in a variety of ways, including from an index or database management file associated with the playlist, from an index or data management file associated with the database 1-2, or from an outside source such as the network 1-4, including the World Wide Web, connected to the retriever 1-1 via a wired or a wireless connection. For example, it may be possible to retrieve the universal ID, if not already contained in the entry on the playlist, from other parts of the local database, or from external sources based on the information available in the entry. Also, additional description data necessary for obtaining the universal media ID may be retrieved from a server 1-5 via the network 1-4 or from the local database 1-2, based on the above-described extracted entry information.

At S4 of FIG. 2 a URL (universal resource locator) or a link or the like is determined for the storage media from where the content data corresponding to the universal ID is to be retrieved. This URL may be to a for proprietary remote database, such as for example, a database of content maintained by the manufacturer or distributor of a home entertainment device, or may be a publicly accessible remote database, such as a merchant where music is provided over the web, such that the remote database provides the content data based on the universal ID. Further, there may be an intermediary server, such as server 1-5, that based on the universal ID provides a URL, link, address or the like to the medium storage server 1-61 where the content item is stored. Alternatively, this task may be performed in two stages, first a server 1-5 can provide the URL for the medium storage server 1-61 then server 1-5 or some other server or database (not shown) can provide, based on the universal ID, the metadata for indexing the medium storage server 1-61 to obtain the content item. In addition, media target associator 1-14 may find the medium storage server 1-61 containing the desired song or content item by referring to the server 1-5 via the network 1-4 which contains a lookup table for determining keying information associated the content data, and based on the keying information associated with the content data, the medium storage server 1-61 may be determined.

At S5, medium storage server 1-61 is contacted via network 1-4. Alternatively, media target associator 1-14 may determine, based on the universal identification, that the content item may be more conveniently retrieved from a local source, such as a database 1-2 or from the media player 1-3.

At S6, the server interface 1-15 provides the universal media ID to the medium storage server 1-6, which returns, at S7, the content data to the server interface 1-15. Medium storage server 1-61 may store the content item desired itself or may be connected to an audio content database 1-62 which stores the content item.

Alternatively, the server 1-5 can determine the content item referenced by the universal ID, and provide a URL to the media target associator 1-4 or direct the retriever 1-1 to the a specific media storage server 1-61 that provides the content data for the content item based on metadata or a non-universal ID provided by the server 1-5 based on the universal ID. In this way, a load on the media storage server 1-61 can be reduced and the media storage server need not be concerned with processing a universal content ID.

At S7, the content data is received by server interface 1-15. It will be understood that the content data may be transmitted to the server interface 1-15 in a compressed format irrespective of the format in which the universal ID was obtained from the content data.

At S8, output 1-16 provides the content item. Output 1-16 may store the content data to a database 1-2 associated with the playlist and with the entry of the playlist for which the entry information was extracted as shown at S8, and output the content item to storage. The content item, together with the remaining content items on the playlist may later be played back or used. Also, the output 1-16 may provide the content data to media player by streaming it to the media player 1-3, whereby media player 1-3 outputs the content data by a speaker 1-31. This is shown at S9, the content item is output to media player. It will be understood that either, or both, S8 and S9 may be performed, as directed by a user, or as set as a default in the playlist generation mode, or as set in the retriever 1-1. Processing is stopped at S10, for example, upon successful retrieval and outputting of the content data, an expiration of an allowable time for the retrieval, cancellation of the retrieval by a user or the like.

Embodiments of the present invention provided in the foregoing written description are intended merely as illustrative examples. It will be understood however, that the scope of the invention is provided in the claims.

What is claimed is:

1. A playlist content retrieval method, comprising:
identifying (S2) a selected entry on a playlist;
extracting (S3), a universal identification for the entry, the universal identification uniquely identifying content data associated with the entry;
retrieving (S7), based on the universal identification, the content data from a medium storage server; and
outputting (S8) the content data.

2. The method of claim 1, wherein the medium storage server identifies the content data based on the universal identification by a hashing algorithm.

3. The method of claim 1, wherein the medium storage server identifies the content data based on the universal identification by reference to a hashing table.

4. The method of claim 1, wherein the universal identification is obtained by applying a hashing function to the content data.

5. The method of claim 1, wherein the outputting is performed by at least one of storing (S9) the content data on a local storage and streaming (S9) the content data to a local output device.

6. The method of claim 1, wherein the content data is retrieved from the medium storage server via a network.

7. The method of claim 1, wherein the content data comprises audio data.

8. The method of claim 1, comprising locating (S4) the medium storage server based on the universal identification.

9. The method of claim 1, wherein metadata retrieved based on the universal ID is provided to the medium storage server for retrieving the content data.

10. A playlist content retrieval system, comprising:
a playlist processor (1-11) configured to identify a selected entry on a playlist;
an entry information extractor (1-12) configured to extract a universal identification for the entry, the universal identification uniquely identifying content data associated with the entry;
a server interface (1-15) configured to retrieve, based on the universal identification, the content data; and
an output (1-16) configured to output the content item.

11. The server of claim 10, wherein a medium storage server identifies the content data based on the universal identification by a hashing algorithm.

12. The server of claim 10, wherein a medium storage server identifies the content data based on the universal identification by reference to a hashing table.

13. The system of claim 10, wherein said output stores the content data associated with the entry on a local storage 1-2.

14. The system of claim 10, wherein said output streams the content data to a local output device 1-3.

15. The system of claim 10, wherein the content data is retrieved from a medium storage server (1-61) via a network (1-4).

16. The system of claim 10, wherein the content data comprises audio data.

17. The system of claim 10, wherein the media target associator locates the medium storage server based on the universal identification.

18. The system of claim 10, comprising a media target associator (1-14) configured to locate a medium storage server (1-61) storing the content data.
